(19) United States
(12) Patent Application Publication
(10) Pub. No.: US 2026/0186167 A1
(43) Pub. Date: Jul. 2, 2026

(54) EVAPOROMETER

(71) Applicant: Oregon State University, Corvallis, OR (US)

(72) Inventor: John Selker, Corvallis, OR (US)

(73) Assignee: Oregon State University, Corvallis, OR (US)

(21) Appl. No.: 19/007,217

(22) Filed: Dec. 31, 2024

(51) Int. Cl. G01W 1/14

(52) U.S. Cl. CPC G01W 1/14

(57) ABSTRACT

A rain gauge/evaporometer comprising a vessel having an interior surrounded by a wall, and a siphon integral with the wall. An inlet of the siphon opens into the interior of the vessel. The rain gauge/evaporometer further comprises a wick contained within the interior of the vessel and having a first volume occupying a major portion of a second volume of the interior of the vessel. A load cell is positioned below the vessel and mechanically coupled to the vessel, and a data collection system electrically coupled to the load cell. The data collection system is housed within a weather-proof enclosure.

### STATEMENT OF GOVERNMENT INTEREST

This application is supported by the National Science Foundation award #1832170. The Government may have some interest in this application.

### BACKGROUND

The amount and timing of rainfall and evaporation are information required in diverse fields, including agriculture and meteorology. Agricultural production is highly sensitive to weather and climate, and thus is central to agricultural management decisions. Measurement of rainfall and irrigation are crucial for predicting crop production, the occurrence of floods and droughts, and weather-related incidents that can impact agriculture, transportation, and other sectors. Additionally, rainfall measurement is used in climate studies to understand long-term climate change patterns. Evaporation measurements are much less commonly obtained due to the technical challenges in gaining these data, but are also important for water management, agriculture, and weather forecasting, and provide insights into the energy exchange between the land and atmosphere, which is a critical component of climate models.

These social needs call for rain gauge systems that robustly provide automatic, timely, continuous, and accurate precipitation and evaporation measurement. Some current problems with rain measurement systems include under-reporting of high rainfall rates due to splash at tipping buckets (of ever greater importance with climate change increasing rainfall intensity), high failure rates in the field due to blockages of small orifices with foreign material including but not limited to dust, seeds, insects, and bird droppings; and mechanical failure due to inclusion of moving parts susceptible to breaking, wear, and insect/spider habitation. The price of purchase of rain measurement gauges is typically far overshadowed by the price of installation, protection, and most of all, the price of maintenance. Even with monthly visits, most rain gauges are subject to failure should a bird defecate in the funnel. This leads to many lost/incomplete records, severely compromising the value of the entire operation. There is a deep need for an improvement over current measurement methods, to improve robustness, decrease loss of data, decrease need for maintenance, and increase accuracy for high-rate rainfall events.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical examples can only approximate illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1 illustrates a profile view of a rain gauge/evaporometer comprising vessel and a wick, in accordance with at least one example.

FIG. 2 illustrates a schematic of a siphon of the rain gauge/evaporometer shown in FIG. 1, in accordance with at least one example.

FIG. 3 illustrates a system block diagram for data collection system coupled to the rain gauge/evaporometer, in accordance with at least one example.

FIG. 4 illustrates a field deployment system, comprising rain gauge/evaporometer and data collection system as a single product, in accordance with at least one example.

FIG. 5 is a flowchart summarizing an exemplary method for using a rain gauge/evaporometer, in accordance with at least one example.

### DETAILED DESCRIPTION

Described herein is a device configured as a rain gauge/evaporometer and comprising a load cell-based rain gauge which measures precipitation and post-rainfall evaporation automatically and accurately. In at least one example, the rain gauge/evaporometer has no moving parts and is designed to operate with minimal maintenance—expecting fewer than one maintenance visit per year. As a rain gauge, it employs a self-emptying bucket or vessel that includes a built-in siphon, in accordance with at least one example. In at least one example, the rain gauge/evaporometer further comprises a porous wick within the vessel that is water-absorbent, which enables filling the vessel to the brim without loss of water. This provides for a constant-geometry aerodynamic system that can accept any rate of incident rainfall with no splashing, while completely blocking entry of any contaminants that might compromise performance. In at least one example, the rain gauge/evaporometer is fitted with a digitally recorded strain gauge type load cell which reports the instantaneous mass of the vessel, while a processor periodically records the instantaneous mass of the vessel. During periods of rain, the weight increases to a threshold, then empties. In at least one example, the periodic or non-periodic filling and emptying events are recorded, and an on-board processor keeps count of the number of filling cycles to determine the amount of rainfall over a specified time.

As an evaporometer, the loss of weight determines a rate of evaporation after a rainfall or irrigation event. In at least one example, a fiberglass filling for a vessel of, for instance, 10 cm depth can retain on the order of 7 cm of water. Due to its high capillarity, the absorbent wick presents a continuously moist surface from which water can evaporate. Tracking changes in bucket weight via a load cell strain gauge enables recording of evaporation after a rain event as weight decreases over time as the absorbent wick dries, in accordance with at last one example. In at least one example, at usual summer evaporation rates, the stored water allows observation of evaporation for about 10 days following the last rainfall. This period can be extended by using a deeper bucket, in at least one example. Since the absorbent wick comprising fiberglass can lift water via capillary forces to, for instance, 2 m, the size of bucket can be made to accommodate evaporation for up to a full year at nearly any site. If the device is employed under agricultural irrigation, re-filling the evaporometer will take place on each irrigation, wherein the device measures both the amount of irrigation and the amount of evaporation.

In at least one example, the evaporometer further comprises a system comprising electronic circuitry that includes a processor and memory to record and store mass vs. time data as it may continually read the load cell. The circuitry includes a power management circuit that provides power to the microprocessor and associated circuitry. As the evaporometer is for autonomous field deployment and operation, the system includes a rechargeable battery and solar cell to charge the battery during the day, and possibly power the processor directly. The device of various examples improves robustness, decreases loss of data, decreases need for maintenance, and increases accuracy for high-rate rainfall events compared to traditional rain gauge/evaporometer.

Here, “siphon” is used as a noun or verb, where the noun is the device, or a state of suction of the device where it spontaneously sucks or pumps a liquid from one place to another by gravity flow. The draining action is initiated by manually or machine pumping water through the main tube of the siphon device. At this point, liquid stops draining from the end of the siphon outside the vessel.

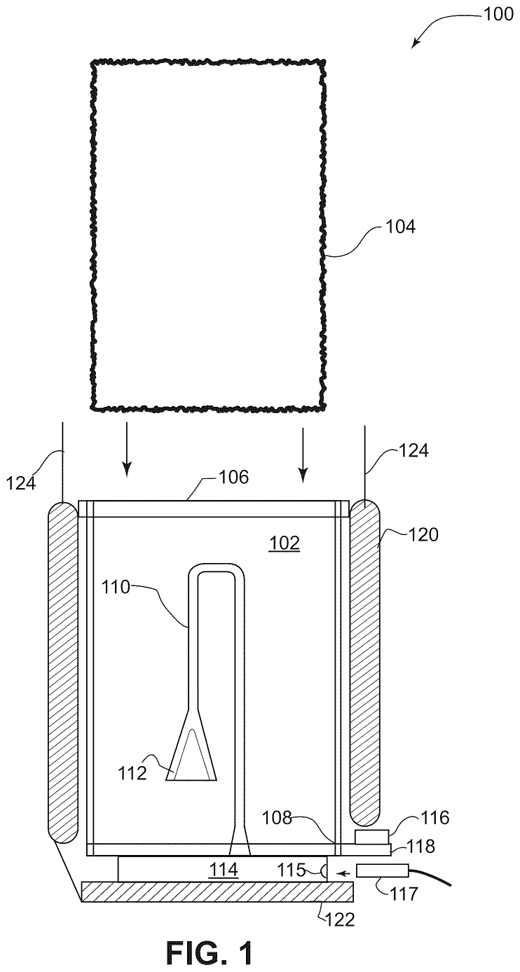

FIG. 1 illustrates a cross-sectional view of a rain gauge/evaporometer 100 comprising a vessel 102 and a wick 104, in accordance with at least one example. In at least one example, wick 104 comprises a water-absorbent material such as fiberglass. In at least one example, vessel 102 comprises a cylindrical bucket-like shape, having an open top 106 and closed bottom 108. In at least one example, a siphon 110 is attached or integral with the exterior wall of vessel 102. In at least one example, siphon 110 comprises a flared mouth to reduce capture of air bubbles and to have a consistent water height when vessel 102 is drained.

In at least one example, wick 104 may comprise loose fibers or a textured/non-textured woven cloth that is folded or wrapped to fit into vessel 102. In at least one example, wick 104 comprises fiberglass fibers. Other fiber compositions may be employed as well, whereby the material is hygroscopic and does not promote growth of molds or mildew. Fiberglass and similar materials also discourage perching or nesting of birds and rodents as it is irritating to animals. In at least one example, wick 104 is insertable into the interior of vessel 102. In at least one example, wick 104 may occupy most of the volume of vessel 102, but due to its hydrophilicity, it absorbs a large percentage of the water. For example, a fiberglass wick may absorb 30% of the water retained in vessel 102.

In at least one example, vessel 102 rests on a load cell 114. Load cell 114 may comprise a strain gauge that is calibrated. The strain gauge stretches as the load, thus the weight of vessel 102, increases. The strain gauge of load cell 114 thus acts as a variable resistor whereby its resistance increases as the strain upon it increases. Other techniques for measuring weight gain and loss may be employed. In at least one example, the weight imposed on the load cell by vessel 102 (containing wick 104 and water) may be determined by measuring the resistance of the strain gauge. In at least one example, load cell 114 may comprise a Wheatstone bridge, by which the unknown resistance leg of the bridge is that of the strain gauge. The compensation resistance of an opposing leg of the bridge to restore equilibrium to the bridge may be determined by a processor and is calibrated for measurement of weight changes.

In at least one embodiment, load cell 114 comprises a port 115 for attachment of an environmental sensor 117, such as a temperature sensor. Attachment of environmental sensor on the body of load cell 114 permits more accurate temperature measurements of the load cell, and if necessary, software may compensate for any temperature-induced artifacts in the weight measurements taken from load cell 114.

In at least one example, rain gauge/evaporometer 100 may optionally include a bubble level 116 mounted on a lower platform 118. Bubble level 116 may aid in mounting rain gauge/evaporometer on a suitably flat surface.

In at least one example, siphon 110 comprises a U-shaped tube that may be integrally formed with vessel 102. In at least one example, vessel 102 and siphon 110 may be formed simultaneously by injection molding. The exit of the siphon might be level with the bottom of the device or might have a vertically downward extension of the outlet to generate greater suction when emptying. The exit of the siphon might be level with the bottom of the device, or might have a vertically downward extension of the outlet to generate greater suction when emptying.

In at least one example, a shroud 120 surrounding vessel 102 is shown in cross section. Shroud 120 may function as a windbreaker and thermal insulation at the same time. Shroud 120 may be attached to a base 122 and fitted over the body of vessel 102 as a jacket. Attachment to base 122 may aid in maintaining a uniform temperature around load cell 114 by mitigating uneven heating of vessel 102 and load cell 114, plus other structures, by sunlight impinging on one side or the other. Such a uniform temperature environment can be used for weight readings using resistive elements. Shroud 120 may be a single ply or double ply cloth or may be filled with an insulation to maintain a quasi-steady temperature of vessel 102. Shroud 120 can greatly reduce the noise on load cell 144 and that improves the accuracy of the device. Shroud 120 can also protect the exterior of the device from direct sunlight, which could influence the measured evaporation. As temperature fluctuations may affect the weight readings, shroud 120 may help to stabilize the temperature of vessel 102, wick 104, and load cell 114. In at least one example, bird spikes 124 may be attached to the top of shroud 120 to help prevent birds from perching on open top 106.

In addition to creating a more uniform thermal environment for rain gauge/evaporometer 100, shroud 120 may also provide some aerodynamic wind-shielding properties that smooth out wind shocks and movement due to wind and gusts of wind. Such sudden movements or motion due to wind can affect load cell readings as random rapid fluctuations in recorded weight readings. Described below is an implementation of a digital filter that may average out sudden fluctuations in the load cell data collected by the data logging system.

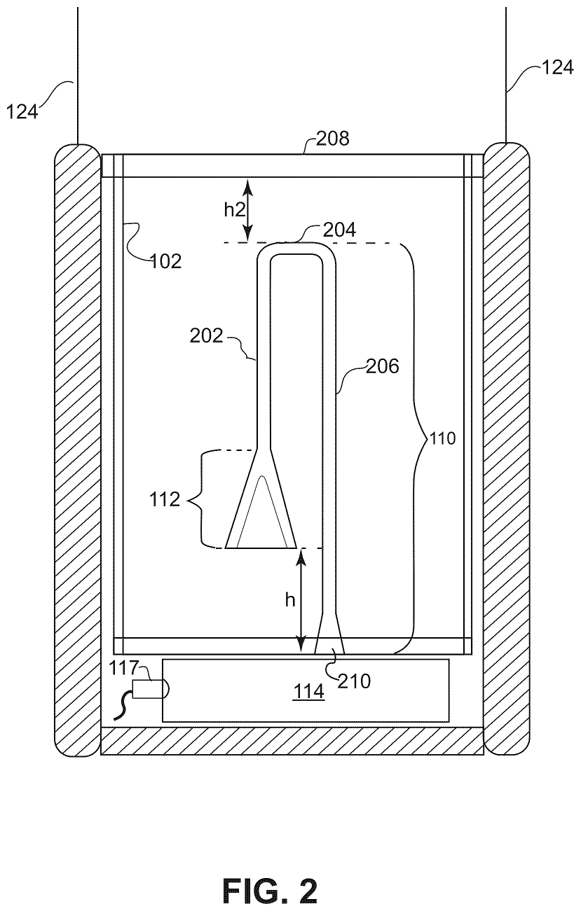

FIG. 2 illustrates a schematic of siphon 110 of rain gauge/evaporometer 100 shown in FIG. 1, in accordance with at least one example. As shown in FIG. 2, the U-shaped tube has two branches. An ascending branch 202 extends upward from flared inlet 112 to apex 204, which curves downward and is contiguous with descending branch 206. Descending branch 206 is longer than ascending branch 202 by an amount h, which provides the pressure head to drive the gravity flow within siphon 110.

In at least one example, apex 204 is a distance d below brim 208 of vessel 102. Distance h2 determines the maximum volume of water that vessel 102 can contain before it will automatically drain. For example, during a rain event, when the water level reaches apex 204, siphon 110 will begin to drain vessel 102 as water within ascending branch 202 begins to spill over to descending branch 206. This places a decreasing pressure on the water column within the totality of siphon 110, enabling water to drain out of outlet 210. The gravity feed pressure of water column in ascending branch 202 pushes water down descending branch 206 and water drains through outlet 210. Outlet 210 is at a distance h below flared inlet 112, whereby h may be engineered for optimal performance. The height differential allows the pressure head to continuously push water through to outlet 210. The water pressure in descending branch 206 remains negative (relative to pressure head at flared inlet 112) until the water level within vessel 102 drops to a level within flared inlet 112 where the pressure head within vessel 102 becomes smaller than ρgh and the siphoning action stops, where r is the water density, g is the gravitational acceleration and h is the height differential between inlet and outlet. Within apex 204, the pressure head is zero. Effectively, the maximum volume of water contained by vessel 102 is determined by distance h2 and is adjustable.

Once siphoning action stops, the vessel is allowed to refill to the extent the rain event lasts. Thus, the vessel fills and empties in a semi-periodic manner, depending on the intensity and duration of the rain event. The time between draining events may be variable, as the intensity of a rainstorm naturally varies along its duration. In at least one example, the filling and draining events are recorded by load cell 114, which records an increasing weight as vessel 102 fills and then a decrease in weight as vessel 102 drains. The time between events depends on the volume of vessel 102. In at least one example, the volume of vessel 102 is partly occupied by wick 104. In at least one example, wick 104 may occupy a significant fraction of the volume of vessel 102. In at least one example, wick 104 may absorb and retain a large fraction of the water collected by vessel 102. One purpose for wick 104 is to prevent splashing water during a rain event. By omission of wick 104, water may splash out of vessel 102 during an intense rainstorm, for example, resulting in an inaccurate record of rainfall. In at least one example, wick 104 mitigates splash-out. In addition, wick 104 may discourage animals such as birds from perching (or nesting) on vessel 102. Their presence may cause weighing errors as well. Wick 104 may also prevent detritus from animals, falling leaves, dead insects, and other natural debris from clogging flared inlet 112 of siphon 110. This action ensures that rainfall (or evaporation) readings are not affected by such natural debris to the extent that clogging of siphon 110 is effectively prevented by wick 104. Wick 104 enables long-term autonomous service of rain gauge/evaporometer 100.

For evaporometer function, wick 104 aids by wicking action of pulling water remaining within vessel 102 after a rain event to brim 208, thus encouraging steady evaporation of water from vessel 102 between rain events. Wick 104 provides a large and constant surface area for consistent water retention and evaporation. Thus, water retained in the fabric of wick 104 is exposed to the air in a consistent manner, bringing water to brim 208 where it is constantly exposed to the open air. Lack of wick 104 may discourage constant evaporation of water as air flow near the bottom of a vessel may stagnate, slowing evaporation as the water level drops.

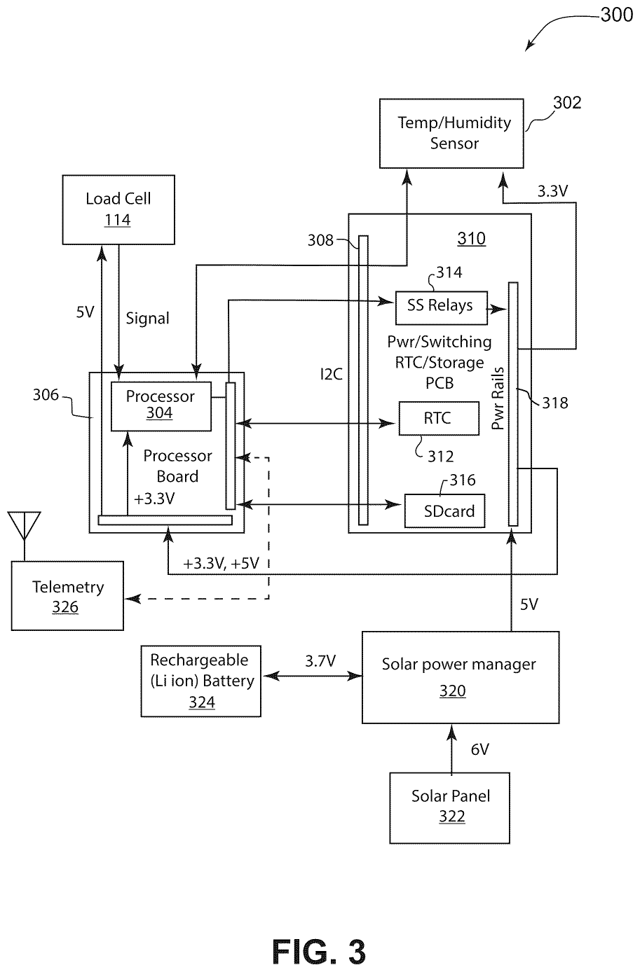

FIG. 3 shows a system block diagram for data collection system 300, comprising load cell 114 and an environmental sensor 302, in accordance with at least one example. In some embodiments, environmental sensor 302 may be a temperature sensor, such as temperature sensor 117 shown in FIG. 1, or may be a humidity sensor (in addition to a temperature sensor). In at least one example, both load cell 114 and environmental sensor 302 communicate with processor 304 (e.g., a Feather™ SAMD21 (by Adafruit) or equivalent, such as an Arduino® Nano or Uno board), residing on processor board 306. In at least one example, processor 304 may communicate with environmental sensor 302 through an inter-integrated circuit (I2C) bus. Here, the I2C bus is indicated as an I/O rail 308 residing on a power switching, real-time clock and storage (PSRTCS) peripheral board 310 that is peripheral to processor board 306. Peripheral board 310 may be a Hypnos™ board, for example.

In at least one example, peripheral board 310 comprises a real-time clock (RTC) 312, a plurality of solid-state (SS) relay switches 314 (e.g., MOSFET switches), and a microSD card 316 for data logging storage, all peripheral components in system 300, controlled or supervised by processor 304 via I/O rail 308, using I2C protocol, for example. In at least one example, RTC 312 keeps track of time of day, and as a power saving service, sends an interrupt signal to put processor 304 to sleep and wake processor 304 from sleep as programmed by processor 304. In at least one example, RTC 312 may wake processor 304 SS for logging load cell data and environmental data, for example, every 5 minutes, while it may sleep between data samples. RTC 312 may alternatively be powered by a 3.3V coin cell battery (not shown), also residing on peripheral board 310. In at least one example, the coin cell battery is capable of continuously delivering power to RTC 312 when external power is disconnected to maintain the processor wake and sleep mode cycles for maximum power saving.

In at least one example, relay switches 314 are controlled by processor 304 to switch off and on power rails 318 and are also power management and saving service. While mechanical relays may be used for this purpose, solid state switches 314 (e.g., MOSFETs) have no moving parts and will not wear out as quickly as mechanical relays. Thus, solid state switches contribute to long term autonomous deployment (e.g., years) of rain gauge/evaporometer 100. In addition, well-planned power management and saving by employing solid state relay switches 314 for switching off power to sensors when not needed may enable long term autonomous functioning of rain gauge/evaporometer 100. In at least one example, solid state relay switches 314 may switch power on and off to power rails 318. Power rails 318 may comprise a +3.3V rail, a +5V rail and a +24V rail (e.g. for Hypnos boards), plus a ground rail.

In at least one example, power is supplied autonomously through solar power manager board 320. A small solar panel 322 may be connected to solar power manager board 320, where solar panel 322 may supply up to 6V at 100 milliamperes, for example, during the day. In at least one example, power output from solar panel 322 may be regulated to 5V, and supply data collection system 300 directly during the day, while simultaneously charging battery 324. In at least one example, battery 324 is a rechargeable 3.7V lithium-ion polymer battery with a charge storage capacity of 10 amp-hours. Depending on the current draw, battery 324 can be capable of supplying power to system 300 for several days without a charge. In at least one example, battery 324 may be utilized during nighttime service when the sun is not shining, and during daytime periods of low sunlight levels causing solar panel 322 to not deliver sufficient power. In at least one example, solar power manager board 320 can top off battery 324 during the day with sufficient sunlight.

Solar power manager board 320 may regulate supplied voltages to 5V and 3.3V, and supply these to power rails 318. Processor 304 may use 3.3V for logic level signals. In another example, environmental sensor 302 may utilize 3.3V as well. These voltages may be delivered through power rails 318 on peripheral board 310.

Load cell 114 may be powered by 5V, for example, which it receives from a power rail residing on processor board 306. In at least one example, load cell 114 may be continuously powered or intermittently powered (e.g., as governed by SS relay switches 314). In at least one example, load cell 114 may output an analog signal, such as a voltage that is proportional to the weight of vessel 102, which is sent directly to an analog-to-digital converter onboard processor 304. In at least one example, processor 304 may communicate with environmental sensor 302 via an I2C bus, where SCL (serial clock) and SDA (serial data) signals are sent and read via I/O rail 308. Environmental sensor 302 may be powered by 3.3V as well.

In at least one example, logged weight-time data may be stored in microSD card 316 on peripheral board 310. MicroSD card 316 may be retrieved periodically or when a particular study is concluded. Real-time clock data from RTC 312 may also be included so that the data may include time stamps. In addition to or in lieu of microSD card 316, a wireless telemetry module 326, such as a LoRa field telemetry interface (e.g., a LoRa transceiver), may be included for real time remote monitoring of logged data.

In at least one example, numerical filters may be included in software that is executed by processor 304. Unlike white noise, which may have a mean of zero but with each successive displacement of values being purely random, impulses from wind result in paired push-pull forces of nearly equal and opposite direction. This symmetry in noise can be exploited in filtering by employing a smoothly changing filter weighting function with a temporal extent that is many times longer than the time between push and pull data. For example, atmospheric turbulence can have periods in the order of 10 seconds, in which case a filter with a 100 second window would be approximately the minimum duration. With the smoothly changing filter shape, the push-pull pairs are always weighted with approximately the same value, so their net contribution to the signal is close to zero. This contrasts with the more normally employed median and boxcar filters. The median value in an interval might shift significantly as the push-signal enters, then altered in the opposite sign as the pull-signal is encountered. This may be the problem with not employing a filter which specifically weights adjacent data at near equal levels. A conventional boxcar filter will also suffer from the sequential inclusion of the push and pull impulses. Such a filter as described herein can achieve an approximately 10-fold reduction in noise between a slowly changing filter (e.g., Gaussian, triangle) and the stepwise windowed filter approaches.

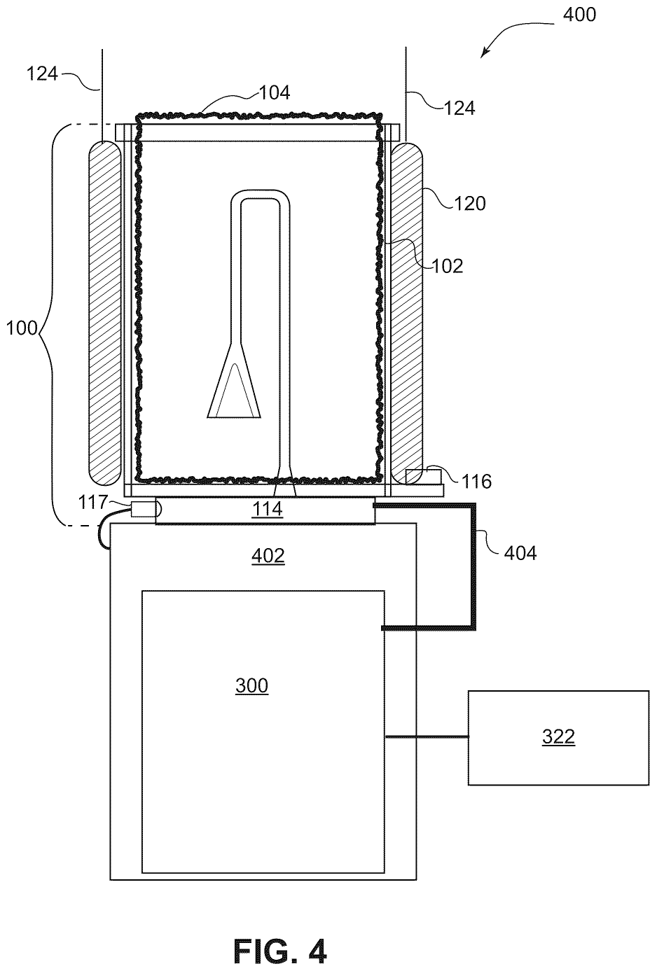

FIG. 4 shows a field deployment system 400, comprising rain gauge/evaporometer 100 and data collection system 300 as a single product, in accordance with at least one example. Here, wick 104 is inserted within vessel 102. Vessel 102 is resting on load cell 114 and may be attached thereto by an adhesive or by fasteners, which in turn may be attached to a weather-proof enclosure 402. Weather-proof enclosure 402 may house the electronics of data collection system 300, comprising the various boards and components that are described above in relation to FIG. 3. For compactness, peripheral board 310 may be stacked over processor board 306 and attached thereto using headers (such as an Arduino hat configuration). In at least one example, load cell 114 is electrically attached to data logging system 300 via cable 404. In at least one example, bubble level 116 may be employed as a level guide to maintain level and plumb when mounting rain gauge/evaporometer 100. In at least one example, solar panel 322 may be mounted at a convenient location adjacent to field deployment system 400. In at least one example, solar panel 322 may be on a frame supported in a separate mount, for example attached to weather-proof enclosure 402.

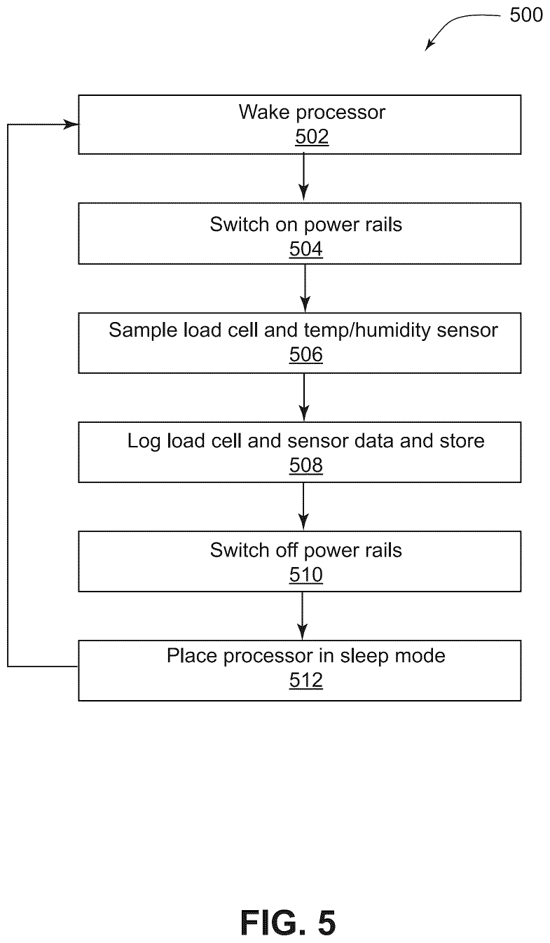

FIG. 5 shows a flowchart 500 summarizing an exemplary method for using rain gauge/evaporometer 100, in accordance with at least one example. While various operational blocks are illustrated in a particular order, the order can be modified. At operation 502, RTC 312 is directed by internal programming to wake processor 304 from sleep mode. RTC 312 may issue an interrupt signal to awaken processor 304.

At operation 504, processor 304 is directed to switch on power rails (e.g., power rails 318 on peripheral board 310. In at least one example, processor 304 sends a control signal (e.g., a logic HI) to gates of one or more of solid-state switches 314 to activate power rails (e.g., power rails 318 on peripheral board 310).

At operation 506, processor 304 samples load cell readings (from load cell 114) as well as optionally sampling readings from environmental sensor 302 per its programming.

At operation 508, processor 304 logs load cell and sensor readings in its internal memory (e.g., SRAM or DRAM), as well as storing the data in microSD card 316. Optionally, processor 304 may send data to telemetry module 326 for wireless transmission of data as telemetry to a network for real time monitoring of data.

At operation 510, once data is logged and/or transmitted, processor 304 is directed by internal programming to shut down power rails. Processor 304 may send a control signal (e.g., a logic LO) to gates of one or more solid-state switches 314, resulting in those switches shutting off power to the power rails.

At operation 512, RTC 312 is directed to place processor 304 in sleep mode according to its internal programming. In at least one example, RTC 312 sends an interrupt signal to processor 304 to place it in sleep mode. RTC 312 remains active when the data collection system 300 is in sleep mode via a coin battery on peripheral board 310.

The method flow is shown to be cyclic. Thus, the method steps repeat periodically to obtain representative rainfall and evaporation data.

Here, some methods and devices may be shown in block diagram form, rather than in detail, to avoid obscuring present disclosure. Reference throughout this specification to “an example,” “one example,” or “some examples” means that a particular feature, structure, function, or characteristic described in connection with an example is included in at least one example of disclosure. Thus, appearances of phrase “in an example,” “in one example,” “in at least one example,” or “some examples” in various places throughout this specification are not necessarily referring to same example of disclosure. Furthermore, particular features, structures, functions, or characteristics can be combined in any suitable manner in one or more examples. For example, a first example can be combined with a second example anywhere particular features, structures, functions, or characteristics associated with two examples are not mutually exclusive. A list of definitions follows, whereby following definitions may provide or augment literal support for claims.

As used in herein, singular forms “a,” “an,” and “the” are intended to include plural forms as well, unless context clearly indicates otherwise. It will also be understood that term “and/or” as used herein refers to and encompasses all possible combinations of one or more of associated listed items.

Here, “coupled” and “connected,” along with their derivatives, may be used to describe functional or structural relationships between components. These terms are not intended as synonyms for each other. Rather, in particular examples, “connected” may be used to indicate that two or more elements are in direct physical, optical, or electrical contact with each other. “Coupled” may be used to indicate that two or more elements are in either direct or indirect (with other intervening elements between them) physical, electrical, or magnetic contact with each other, and/or that two or more elements co-operate or interact with each other (e.g., as in a cause-and-effect relationship). “Coupled” may also have the meaning of non-mechanical contact or connection. “Coupling” may also mean: thermal connectivity, where one object may be a heat source and another object may be a heat sink, either in thermal equilibrium with each other or subject to a common conductive, convective, or radiative heat flow between them; electrical coupling, where objects may be connected electrically in an electric or electronic circuit and a current flow may be induced by application of a voltage between the electrically interconnected objects or by an electric field between mechanically coupled or isolated objects; magnetic coupling, where two mechanically coupled or isolated objects mutually share a common magnetic field flux; and fluidical coupling, where objects such as vessels and conduits may share a common gas or liquid fluid, that is static or flowing.

Here, a device that is “configured to” perform a task or function may be configured (e.g., programmed and/or hardwired) at a time of manufacturing by a manufacturer to perform the function. In at least one example, the device may be configurable (or reconfigurable) by a user after manufacturing to perform the function and/or other additional or alternative functions. In at least one example, the configuring may be through firmware and/or software programming of the device, through a construction and/or layout of hardware components and interconnections of the device, or a combination thereof.

Here, “between” may be employed in context of z-axis, x-axis, or y-axis of a device. A material that is between two other materials may be in contact with one or both of those materials. In another example, a material that is between two or more materials may be separated from both of other two materials by one or more intervening materials. A material “between” two other materials may therefore be in contact with either of the other two materials. In another example, a material “between” two other materials may be coupled to the other two materials through an intervening material. A device that is between two other devices may be directly connected to one or both of those devices. In another example, a device that is between two other devices may be separated from both of the other two devices by one or more intervening devices.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” the second material if device is oriented upside-down relative to context of figure provided. Similar distinctions are to be made in context of component assemblies.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one example, such variation is no more than +/−10% of referred value.

In the following paragraphs, examples are provided that illustrate various examples. Examples can be combined with other examples. As such, various examples can be combined with other examples without changing scope of disclosure.

Example 1 is a rain gauge/evaporometer comprising: a vessel having an interior surrounded by a wall; a siphon integral with the wall, wherein an inlet of the siphon opens into the interior of the vessel; a wick contained within the interior of the vessel and having a first volume that occupies a major portion of a second volume of the interior of the vessel; a shroud surrounding the vessel; and a load cell below the vessel and mechanically coupled thereto.

Example 2 is a rain gauge/evaporometer according to any example herein, in particular example 1, wherein the wick comprises a water-absorbent material.

Example 3 is a rain gauge/evaporometer according to any example herein, in particular example 2, wherein the water-absorbent material is mold and mildew resistant.

Example 4 is a rain gauge/evaporometer according to any example herein, in particular example 2, wherein the water-absorbent material comprises fiberglass.

Example 5 is a rain gauge/evaporometer according to any example herein, in particular example 1, wherein the wick comprises loose fibers.

Example 6 is a rain gauge/evaporometer according to any example herein, in particular example 1, wherein the wick comprises a woven cloth.

Example 7 is a rain gauge/evaporometer according to any example herein, in particular example 1, wherein the siphon comprises a flared inlet.

Example 8 is a rain gauge/evaporometer according to any example herein, in particular example 7, wherein the flared inlet communicates with an ascending branch of the siphon.

Example 9 is a rain gauge/evaporometer according to any example herein, in particular example 8, wherein the ascending branch is coupled to a first end of an apex portion of the siphon.

Example 10 is a rain gauge/evaporometer according to any example herein, in particular example 9, wherein a descending branch is coupled to a second end of the apex portion.

Example 11 is a rain gauge/evaporometer according to any example herein, in particular example 10, wherein the descending branch extends a distance below the flared inlet, wherein the distance is a difference between a first length of the ascending branch and a second length of the descending branch, and wherein the descending branch terminates at an outlet of the siphon.

Example 12 is a rain gauge/evaporometer according to any example herein, in particular example 1, further comprising a bubble level.

Example 13 is a rain gauge/environmental sensor according to any example herein, in particular example 1, wherein a temperature sensor is attached to the load cell.

Example 14 is a rain gauge/evaporometer according to any example herein, in particular example 1, wherein the shroud is attached to a base, wherein the base is attached below the load cell.

Example 15 is a rain gauge/evaporometer as in any example herein, in particular example 1, wherein bird spikes are attached to a top of the shroud.

Example 16 is a rain gauge/evaporometer system, comprising: a rain gauge/evaporometer, comprising: a vessel having an interior surrounded by a wall; a siphon integral with the wall, wherein an inlet of the siphon opens into the interior of the vessel; a wick contained within the interior of the vessel and having a first volume occupying a major portion of a second volume of the interior of the vessel; and a load cell below the vessel and mechanically coupled thereto; and a data collection system electrically coupled to the load cell, wherein the data collection system is housed within an enclosure.

Example 17 is a rain gauge/evaporometer system according to any example herein, in particular example 16, further comprising a solar panel coupled to the data collection system, wherein the solar panel is deployed on an exterior of the enclosure.

Example 18 is a rain gauge/evaporometer system according to any example herein, in particular example 16, wherein the enclosure is a weather-proof enclosure.

Example 19 is a rain gauge/evaporometer system according to any example herein, in particular example 16, wherein the load cell is attached to the vessel by an adhesive or by fasteners.

Example 20 is a rain gauge/evaporometer system according to any example herein, in particular example 16, wherein the load cell comprises a strain gauge coupled to the data collection system.

Example 21 is a rain gauge/evaporometer system according to any example herein, in particular example 16, wherein the data collection system comprises a processor board and a peripheral board, wherein the peripheral board comprises one or more components coupled to a processor on the processor board.

Example 22 is a rain gauge/evaporometer system according to any example herein, in particular example 21, wherein the processor is coupled to the load cell and to an environmental sensor.

Example 23 is a rain gauge/evaporometer system according to any example herein, in particular example 21, wherein the processor is coupled to one or more solid state switches on the peripheral board.

Example 24 is a rain gauge/evaporometer system according to any example herein, in particular example 21, wherein the processor is coupled to a real time clock on the peripheral board.

Example 25 is a rain gauge/evaporometer system according to any example herein, in particular example 21, wherein the processor is coupled to a microSD card on the peripheral board.

Example 26 is a rain gauge/evaporometer system according to any example herein, in particular example 21, wherein a solar power manager is coupled to the peripheral board, and wherein the solar power manager is coupled to a solar panel.

Example 27 is a rain gauge/evaporometer system according to any example herein, in particular example 26, wherein the solar power manager is coupled to a rechargeable battery.

Example 28 is a rain gauge/evaporometer system according to any example herein, in particular example 21, wherein the processor is coupled to a telemetry module.

Example 29 is a method for using automatically field-measuring rainfall or rate of evaporation, comprising: deploying a rain gauge/evaporometer, wherein the rain gauge/evaporometer comprises: a vessel having an interior surrounded by a wall; a siphon integral with the wall, wherein an inlet of the siphon opens into the interior of the vessel; a wick contained within the interior of the vessel and having a first volume occupying a major portion of a second volume of the interior of the vessel; a load cell below the vessel and mechanically coupled thereto; and a data collection system electrically coupled to the load cell, wherein the data collection system comprises a processor; waking the processor from a sleep mode after a time interval; switching on one or more power rails; reading an output from the load cell and converting it to a vessel weight datum; and logging the vessel weight datum in a memory and storing the vessel weight datum.

Example 30 is a method according to any example herein, in particular example 29,further comprising switching off the one or more power rails.

Example 31 is a method according to any example herein, in particular example 29,further comprising placing the processor in the sleep mode.

Example 32 is a method according to any example herein, in particular example 29,wherein switching on the one or more power rails comprises sending out a control signal to one or more solid state switches, wherein the control signal is issued by the processor.

Example 33 is a method according to any example herein, in particular example 29,wherein waking the processor from the sleep mode comprises an interrupt signal to the processor, wherein a real time clock within the data collection system issues the interrupt signal.

Besides what is described herein, various modifications can be made to disclosed examples and examples thereof without departing from their scope. Therefore, illustrations of examples herein should be construed as examples, and not restrictive to scope of present disclosure.

What is claimed is:

1. A rain gauge/evaporometer comprising:
a vessel having an interior surrounded by a wall;
a siphon integral with the wall, wherein an inlet of the siphon opens into the interior of the vessel;
a wick contained within the interior of the vessel and having a first volume that occupies a major portion of a second volume of the interior of the vessel;
a shroud surrounding the vessel; and
a load cell below the vessel and mechanically coupled thereto.

2. The rain gauge/evaporometer of claim 1, wherein the wick comprises a water-absorbent material.

3. The rain gauge/evaporometer of claim 2, wherein the water-absorbent material is mold and mildew resistant.

4. The rain gauge/evaporometer of claim 2, wherein the water-absorbent material comprises fiberglass.

5. The rain gauge/evaporometer of claim 1, wherein the wick comprises loose fibers.

6. The rain gauge/evaporometer of claim 1, wherein the wick comprises a woven cloth.

7. The rain gauge/evaporometer of claim 1, wherein the siphon comprises a flared inlet.

8. The rain gauge/evaporometer of claim 7, wherein the flared inlet communicates with an ascending branch of the siphon.

9. The rain gauge/evaporometer of claim 8, wherein the ascending branch is coupled to a first end of an apex portion of the siphon.

10. The rain gauge/evaporometer of claim 9, wherein a descending branch is coupled to a second end of the apex portion.

11. The rain gauge/evaporometer of claim 10, wherein the descending branch extends a distance below the flared inlet, wherein the distance is a difference between a first length of the ascending branch and a second length of the descending branch, and wherein the descending branch terminates at an outlet of the siphon.

12. The rain gauge/evaporometer of claim 1, further comprising a bubble level.

13. The rain gauge/evaporometer of claim 1, wherein a temperature sensor is attached to the load cell.

14. The rain gauge/evaporometer of claim 1, wherein the shroud is attached to a base, wherein the base is attached below the load cell.

15. The rain gauge/evaporometer of claim 1, wherein bird spikes are attached to a top of the shroud.

16. A rain gauge/evaporometer system, comprising:
a rain gauge/evaporometer, comprising:
a vessel having an interior surrounded by a wall;
a siphon integral with the wall, wherein an inlet of the siphon opens into the interior of the vessel;
a wick contained within the interior of the vessel and having a first volume occupying a major portion of a second volume of the interior of the vessel;
a shroud surrounding the vessel; and
a load cell below the vessel and mechanically coupled thereto; and
a data collection system electrically coupled to the load cell, wherein the data collection system is housed within an enclosure.

17. The rain gauge/evaporometer system of claim 16, further comprising a solar panel coupled to the data collection system, wherein the solar panel is deployed on an exterior of the enclosure.

18. The rain gauge/evaporometer system of claim 16, wherein the enclosure is a weather-proof enclosure.

19. The rain gauge/evaporometer system of claim 16, wherein the load cell is attached to the vessel by an adhesive or by fasteners.

20. The rain gauge/evaporometer system of claim 16, wherein the load cell comprises a strain gauge coupled to the data collection system.

21. The rain gauge/evaporometer system of claim 16, wherein the data collection system comprises a processor board and a peripheral board, wherein the peripheral board comprises one or more components coupled to a processor on the processor board.

22. The rain gauge/evaporometer system of claim 21, wherein the processor is coupled to the load cell and to an environmental sensor.

23. The rain gauge/evaporometer system of claim 21, wherein the processor is coupled to one or more solid state switches on the peripheral board.

24. The rain gauge/evaporometer system of claim 21, wherein the processor is coupled to a real time clock on the peripheral board.

25. The rain gauge/evaporometer system of claim 21, wherein the processor is coupled to a microSD card on the peripheral board.

26. The rain gauge/evaporometer system of claim 21, wherein a solar power manager is coupled to the peripheral board, and wherein the solar power manager is coupled to a solar panel.

27. The rain gauge/evaporometer system of claim 26 wherein the solar power manager is coupled to a rechargeable battery.

28. The rain gauge/evaporometer system of claim 23, wherein the processor is coupled to a telemetry module.

29. A method for using automatically field-measuring rainfall or rate of evaporation, comprising:
deploying a rain gauge/evaporometer, wherein the rain gauge/evaporometer comprises:
a vessel having an interior surrounded by a wall;
a siphon integral with the wall, wherein an inlet of the siphon opens into the interior of the vessel;
a wick contained within the interior of the vessel and having a first volume occupying a major portion of a second volume of the interior of the vessel;
a load cell below the vessel and mechanically coupled thereto; and
a data collection system electrically coupled to the load cell, wherein the data collection system comprises a processor;
waking the processor from a sleep mode after a time interval;
switching on one or more power rails;
reading an output from the load cell and converting it to a vessel weight datum; and
logging the vessel weight datum in a memory and storing the vessel weight datum.

30. The method of claim 29, further comprising switching off the one or more power rails.

31. The method of claim 29, further comprising placing the processor in the sleep mode.

32. The method of claim 29, wherein switching on the one or more power rails comprises sending out a control signal to one or more solid state switches, wherein the control signal is issued by the processor.

33. The method of claim 29, wherein waking the processor from the sleep mode comprises an interrupt signal to the processor, wherein a real time clock within the data collection system issues the interrupt signal.
